(19) United States
(12) Patent Application Publication
(10) Pub. No.: US 2005/0234598 A1
(43) Pub. Date: Oct. 20, 2005

(54) Autonomous agents for coordinated diagnostics, reconfiguration, and control for coupled systems

(76) Inventors: Frederick M. Discenzo, Brecksville, OH (US); Francisco P. Maturana, Mayfield Heights, OH (US); Raymond J. Staron, Richmond Heights, OH (US); Pavel Tichy, Nymburk (CZ); Petr Slechta, Ceska Lipa (CZ); Vladimir Marik, Prague (CZ)

Correspondence Address: ROCKWELL AUTOMATION, INC./(QB), ATTENTION: SUSAN M. DONAHUE, 1201 SOUTH SECOND STREET, MILWAUKEE, WI, 53204, US

(21) Appl. No.: 11/107,031

(22) Filed: Apr. 15, 2005

Related U.S. Application Data
(60) Provisional application No. 60/563,247, filed on Apr. 15, 2004.

(51) Int. Cl. G05D 7/00

(52) U.S. Cl. 700/282; 700/286

(57) ABSTRACT

Autonomous cooperative units working together to solve diagnostics, monitoring, surveillance, reconfiguration, and control problems may be organized into clusters and cluster associations, for example along the lines of a particular distribution system for water, power or the like. The clusters allow controlled communication among agents within different services and support the coordinated diagnostics, reconfiguration, and control across coupled systems.

### CROSS-REFERENCE TO RELATED APPLICATIONS

This application claims the benefit of U.S. provisional application 60/563,247 filed Apr. 15, 2004 hereby incorporated by reference.

### STATEMENT REGARDING FEDERALLY SPONSORED RESEARCH OR DEVELOPMENT

### BACKGROUND OF THE INVENTION

The present invention relates to computerized automation systems and in particular to automation systems employing autonomous cooperating units (“ACU”).

Distribution systems, for example, those found in a modem warship, distribute materials such as fuel, ballast water, fire water, chilled water and compressed air, fresh air, as well as electrical power, to different points in the ship and to various devices, machines, computers, and other electronic equipment. Materials, air, and power flow through complex networks of conduits or wiring that form branches between nodes such as pumps, generators, valves, switches, sensors and the like.

Under changing demand, disturbances, or disruption to the networks, the networks may be reconfigured, taking advantage of redundancy built into the nodes and branches of the distribution system and the priority of users. For example, in a warship, chilled water provides cooling for critical electrical components and machines such as radar, communications equipment, and armaments, as well as cooling for crew quarters and work areas. Should the network be damaged through the loss of a section of pipe or a pump failure or water chiller failure, autonomous agents may collaborate to confirm the type and extent of damage or failure. Further collaboration may result in control valves being adjusted to minimize water loss or reduce consequential damage. Subsequent collaboration may establish routing plans to route chilled water around damaged pipe sections to critical heat loads and re-allocating cooling capacity from less critical needs to critical ship systems. If sufficient chilled water cannot be obtained, further, more drastic reconfiguration options may be exercised such as violating the segregation of chilled water between port and starboard sides of the ship.

Effectively controlling a complex chilled water system with a commercial programmable logic controller (PLC) is difficult, requiring the anticipation and preparation of pre-programmed responses for each of a large number of possible combinations of water demand, system disturbances, and network component availability or failure, according to changing strategic goals. U.S. application Ser. No. 10/737,384 filed Dec. 16, 2003, hereby incorporated by reference and assigned to the same assignee as the present invention, describes a control system for chilled water or other materials in which the various nodes and branches of the distribution network are associated with autonomous cooperating units (“ACUs”). The ACUs independently provide reasoning about component health or condition and electrical control or sensing of a different component of the distribution network, for example, a pump, pipe or valve. Together, the ACUs receive generalized instructions for the delivery of chilled water and then organize themselves, according to a bidding process, to deliver the water as required. Because the bidding process reflects the current state of the distribution system (e.g., ACUs don't bid for tasks if their associated components are damaged) an efficient solution may be obtained even when the distribution network is subject to unanticipated damage.

The ACU architecture can provide better control over a distribution system than manual systems or conventional centralized control systems can.

### SUMMARY OF THE INVENTION

The present inventors have recognized that a given distribution system is ordinarily operating in parallel with other distribution systems and operational systems (e.g. ship propulsion) that inevitably both augment and compete with the given distribution systems for limited resources. Improved control of a distribution system may be possible by cross communication among parallel distribution systems enabled by the versatility, speed, and scalability of the ACU architecture.

For example, by allowing communication between a chilled water distribution system and the electrical power distribution, the chilled water system can invoke power resources in bidding, for example, by bidding for additional power for a power degraded pump. The degraded pump may have a worn impellor requiring the motor to run at a much higher speed to maintain the required hydraulic head or flow rate. Given that this is a viable operating scenario, the motor-pump control agent may request additional power from the associate owner control agent in order to realize the new, higher pump speed operating scenario.

The significantly increased complexity of such a cross-connected or coupled system is managed through the use of a cluster structure that flexibly and dynamically controls the degree to which such cross-communication between and among agents in different ship services occurs. By changing the cluster structure, flexible trade-offs are achieved between, on the one hand, rapid and efficient organization of a limited number of autonomous cooperative units and, on the other hand, highly sophisticated control requiring communication of far larger numbers of autonomous cooperative units.

Specifically then, the present invention provides an autonomous control system for managing at least two different distribution services, each distribution service providing distribution nodes and branches. The at least two different distribution services are coupled in the sense that a change in one service may impact the other service or an alteration in one service is required to realize a change in the other service. The autonomous control system includes a plurality of autonomous cooperative units, at least some of which are associated with nodes and branches of each distribution service. Each autonomous cooperative unit is programmed to cooperatively implement a job command by a bidding process among autonomous cooperative units associated with a predefined cluster related to one of the distribution services. At least one of the autonomous cooperative units is programmed to cooperatively implement the job command by a bidding process among autonomous cooperative units associated with a predefined cluster related to at least two of the distribution services.

Thus, it is one objective of at least one embodiment of the invention to provide a more sophisticated control of distribution services by communication with coupled distribution services.

The distribution services may include the distribution of a physical material, for example, compressed air, chilled water, fuel, chilled air and ballast water.

Thus it is another objective of at least one embodiment of the invention to provide a system that is well suited for distribution of utilities and the like, for example on a warship, in an aircraft, or in a municipality.

The nodes may be motor-pumps, tanks, chillers, heaters, valves, and the branches pipes.

Thus it is another objective of at least one embodiment of the invention to provide a distribution control system that works with a wide variety of distribution services.

The distribution service may include the distribution of electrical power, in which case the nodes may be switches, power controllers, power sources (e.g. generators or batteries) and power sinks (e.g. motors or electrical equipment) and the branches wire.

It is thus another objective of at least one embodiment of the invention to provide a control system that allows for intercommunication between a distributed utility and the power which services the nodes and branches of that utility.

The autonomous cooperative units that are associated with at least two of the distribution services may not be associated with nodes or branches of either distribution service.)

Thus it is another objective of at least one embodiment of the invention to allow for a hierarchical communication between distribution services using agents dedicated solely to that intercommunication. Such an agent is referred to as a cluster agent.

The system may include a plurality of directory facilitators communicating with the multiple autonomous cooperative units, wherein the autonomous cooperative units communicate in the bidding process among autonomous cooperative units of a predefined cluster defined by the directory facilitator.

Thus it is an object of at least one embodiment of the invention to provide for a mechanism to flexibly change the clusters on a dynamic basis.

It is another object of at least one embodiment of the invention to manage the communication among agents according to desired trade-offs by changing cluster sizes and cluster members using the directory facilitators.

The autonomous control unit may connect to different numbers of directory facilitators under predefined conditions of the bidding process.

Thus it is an object of at least one embodiment of the invention to allow change in clusters, including the destruction of clusters and the formation of new clusters during the bidding process as required.

These particular objects and advantages may apply to only some embodiments falling within the claims and thus do not define the scope of the invention.

### BRIEF DESCRIPTION OF THE DRAWINGS

FIG. 1 is a phantom view of a warship showing a simplified set of distribution systems for chilled water, electrical power and compressed air having nodes and branches under the control of autonomous control units;

FIG. 2 is a schematic representation of these multiple distribution systems showing agents for control of the various nodes and branches of FIG. 1 communicating among themselves and showing communications across coupled distribution services per the present invention;

FIG. 3 is a schematic representation of the distribution systems of FIG. 2 showing a logical clustering of agents according to clusters defined by directory facilitators the latter of which may be changed to change the cluster sizes; and

FIG. 4 is a more detailed view of a directory facilitator communicating with an agent showing a change of cluster scope according to the results of the bidding process.

### DETAILED DESCRIPTION OF THE PREFERRED EMBODIMENT

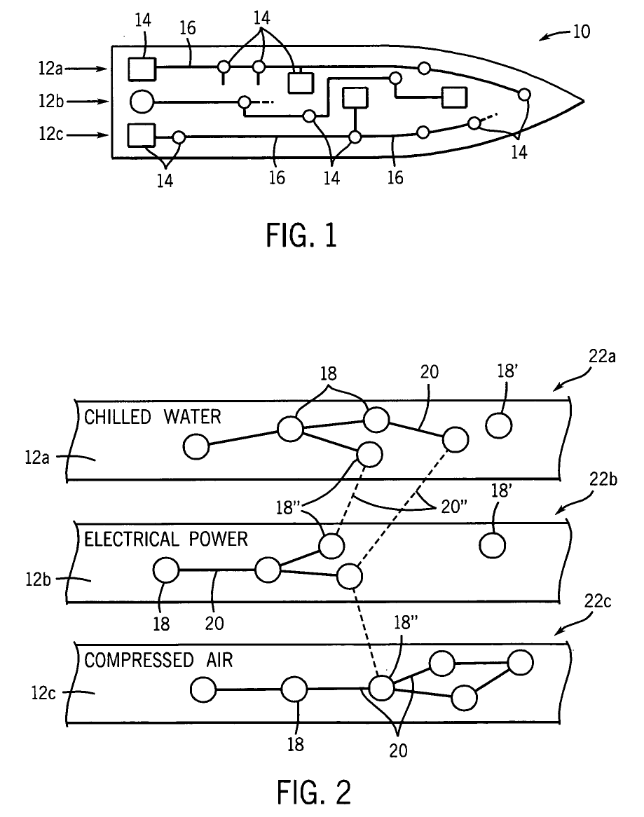

Referring now to FIG. 1, a warship 10 may have a variety of separate distribution services, for example, including a chilled water service 12a, an electrical power service 12b, and a compressed air service 12c, each for distributing respectively, chilled water, electrical power and compressed air throughout the warship 10. The warship 10 is representative of a general distribution system infrastructure such as may be found in other systems such as aircraft and submarines, and in environments such as factories and cities.

Each of the distribution services 12 may be characterized as a set of nodes 14 joined by branches 16. For the chilled water service 12a and the compressed air service 12c, the nodes 14 may be motor-pumps, tanks, valves and sensors and the branches 16 pipes. In the case of the electrical power service 12b, the nodes 14 may be generators, batteries, fuel cells, power loads, power converters, switches and sensors and the branches 16 wires. Other distribution services that distribute utilities such as fuel, compressed air, fresh conditioned air, fire water, elevators, and ballast water may also be found in the warship 10 but are not shown for clarity. Generally but not necessarily, each of the distribution services 12 operates independently, in parallel, and shares no common nodes 14 or branches 16.

Referring now to FIG. 2, each distribution service 12a-12c may be controlled by a series of autonomous control units (ACUs) 18. ACUs 18 suitable for use in the present invention are described in U.S. patents: U.S. Pat. No. 6,091,998 issued Jul. 18, 2000; U.S. Pat. No. 6,272,391 issued Aug. 7, 2001; and U.S. Pat. No. 6,647,300 issued Nov. 11, 2003; and pending U.S. applications: Ser. No. 09/407,474 filed Sep. 28, 1999; Ser. No. 09/621,718, filed Jul. 24, 2000; and Ser. No. 10/242,597 filed Sep. 12, 2002 all assigned to the present assignee and hereby incorporated by reference.

Each ACU 18 represents a separate logical entity capable that may be associated with each of the nodes 14 and branches 16 to monitor that particular component of the distribution service 12 and to act as its agent in organizing the components to work together in particular distribution tasks.

Each ACU 18 is logically separate and preferably many ACUs 18 are independent electronic computers so as to provide a distributed computing environment more tolerant of damage and providing sustained operation if several components fail or become disabled. The ACUs 18 communicate with each other preferably by means of a network of a type well known in the art (not shown).

As described in the above referenced patents and co-pending U.S. patent applications, each ACU 18 is programmed with: generalized knowledge of the capabilities of its associated node 14 or branch 16, the functional connections between its associated node 14 or branch 16 and at least some other nodes 14 and branches 16, a bidding protocol, and the ability to interpret and parse a job instruction written in a job description language (JDL).

Based on a job instruction provided to the ACUs 18 and propagated through the network, for example, to deliver a certain quantity of chilled water to a particular consumer, the ACUs 18 may organize themselves to complete the job based on the current capabilities of their associated nodes 14 and branches 16 and previous commitments of these resources or perhaps likely or expected future capabilities or future operating requirements. In organizing themselves, the ACUs 18 identify portions of the job that they can complete and pass other portions of the job along to other ACUs 18 associated with nodes 14 or branches 16 that may complete the remaining portions of the job. The passage of the job among the ACUs 18 creates bid chains which ultimately are compared to select a winning bid.

In creating the bid chain, each ACU 18 looks at a subset of other ACUs 18 and 18′, within a “cluster” for complementary resources needed to complete the job. Thus, ACUs 18 and 18′ evaluating a job for delivery of chilled water communicate with those ACUs 18 and 18′ associated with nodes 14 and branches 16 of the chilled water service 12a. Only ACUs 18 from this cluster will be part of the winning bid. Thus the chilled water service 12a defines generally a cluster 22a, the electrical power service 12b defines generally a cluster 22b and the compressed air service 12c defines generally a cluster 22c and typically jobs related to a particular service is passed primarily among the ACUs 18 within the clusters 22 of these services. The use of clusters 22a-22c greatly simplifies the bidding process by limiting the universe of potential bid participants and bid permutations.

The topology of a given organization of ACUs 18 is shown by communication paths 20 representing communications between the ACUs 18 required for the execution of that job and representing a subset of the larger scale communication between ACUs 18 over the network during the organizational process.

As will be understood by those of ordinary skill in the art from this description and the cited applications, a similar organization of ACUs 18 can be effected for the electrical power service 12b and the compressed air service 12c, each controlled by separate job instructions passed among independent ACUs associated with those particular distribution services 12.

As a first approximation, a job of distributing chilled water will best be addressed by ACUs 18 associated with nodes 14 and branches 16 (shown in FIG. 1) of the chilled water cluster 22a and similarly the job of distributing electrical power and compressed air will best be addressed by ACUs 18 associated with the electrical power cluster 22b and compressed air cluster 22c respectively.

Nevertheless, the present inventors have determined that despite this logical partitioning of ACUs 18 into clusters 22a, 22b and 22c, improved solutions sets can be obtained in some cases by allowing certain ACUs 18″ to communicate with multiple different clusters. Thus one ACU 18″ of cluster 22a may communicate with a corresponding ACU 18″ of electrical power cluster 22b.

This communication across clusters 22 may be illustrated by a simple example in which a water distribution problem occurs because of failure of a pump. ACUs 18 looking solely within their cluster 22a may attempt to reroute the water flow using a secondary or backup pumps, but in certain cases that may be impossible or may carry with it an extremely high performance penalty. By allowing some of the ACUs 18″ of chilled water cluster 22a to communicate with ACUs 18″ of electrical power cluster 22b, the ACUs 18 may discover, for example, that the pump failure was caused by a lack of electrical power or a power problem such as a phase imbalance. Cooperation between chilled water clusters 22a and electrical power cluster 22b through this communication path 20″ can allow this knowledge to be incorporated into the optimization of the bidding process of each service (i.e. chilled water and electrical power) while preserving the cluster concept prevents the need for a complete expansion of the solution space such as could create problems of communication bandwidth and solution convergence. The association of nodes from different clusters 22 is called a cluster association.

In the example of FIG. 2, selected ACUs 18″ will communicate with other ACUs 18″ across boundaries of clusters 22a, 22b and 22c as may be appropriate. For example, typically an ACU 18 associated with a pipe of a chilled water service 12a may not communicate with ACU 18 associated with the electrical cluster 22b, but in the example of the failed pump above, such communication could be useful. In a similar manner, ACUs 18″ of the electrical power cluster 22b may communicate with the ACUs 18″ of the compressed air cluster 22c and ACUs 18″ of the compressed air cluster 22c may communicate with the chilled water cluster 22a. Generally this intercommunication provides both individual information for optimization and the possible enlisting of resources from the other distribution services 12, for example, by shutting down an air compressor to save electrical power to provide for chilled water. It also provides for the coordinated reconfiguration of individual services that are coupled, e.g., electrically, mechanically, or functionally.

Limited connections between the clusters 22a-22c limits the scalability problems of having too many agents interconnected. It will be understood from review of FIG. 2 that certain of the ACUs 18″ are associated with multiple clusters, for example clusters 22a and 22b.

Note that the present system allows for multiple overlapping clusters 22. A pump may be, for example, in a cluster 22 associated with a ballast water distribution service (not shown) and may also be in a cluster 22 associated with a fire water distribution service (not shown). Further, a particular resource (e.g. motor, pump, pipe) may be used in a way not intended during unusual conditions. I understand this is not unique. For example, fuel tanks may be filled with ballast water in emergency conditions. This unusual operating condition may be readily managed by agent clusters.

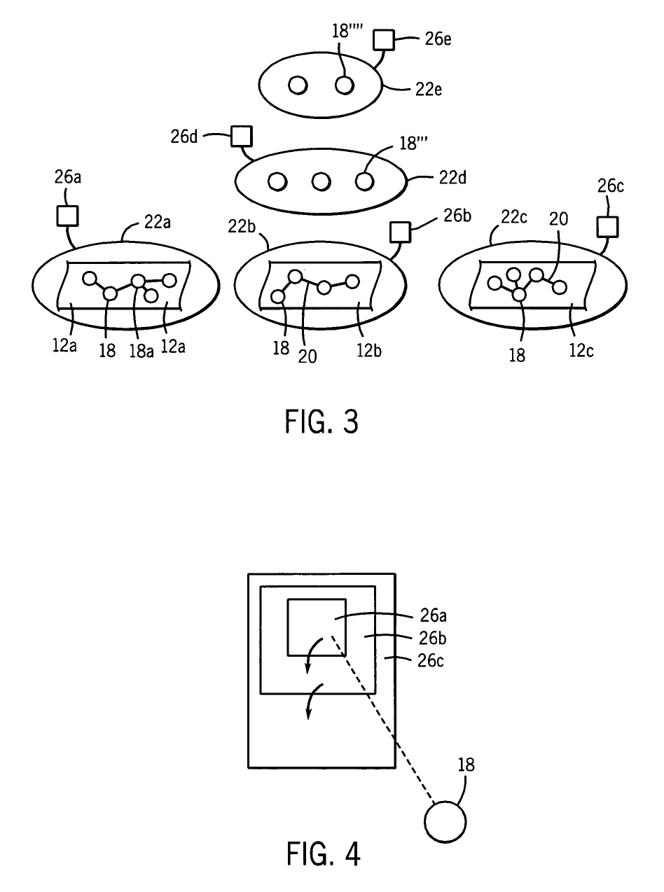

Referring now to FIG. 3, in an alternative embodiment particular ACUs 18′″ may be used to provide for the intercommunication between the ACUs 18 of each of the distribution services 12a, 12b and 12c, these ACUs 18′″ acting in a supervisory capacity as part of a new cluster 22d. As a general matter, this supervisory capacity may be extended in hierarchical form to provide for a second higher level of ACUs 18′″ forming top level cluster 22e. In this way, separate job instructions, for example providing for priorities between different distribution services 12a, 12b and 12c or interoperability functions may be integrated into the control process.

The definition of the clusters 22 may be made in a number of ways, including, for example, programming into each of the ACUs 18 knowledge of its cluster 22. In this case, the ACUs 18 communicate with only the ACUs 18 of their clusters 22, thus limiting bands with demands on the system. Alternatively, a directory-type system such as is described in the above referenced U.S. patent applications may be created using a series of directory facilitators 26a-26e, each associated with one of the clusters 22a-22e. An individual ACU, for example ACU 18a in cluster 22a associated with the chilled water service 12a, may thus determine its cluster by communicating with a particular pre-assigned directory facilitator 26a, which lists other ACUs 18 and their capabilities within the particular cluster 22a, to which ACU 18a belongs.

The directory facilitator 26a not only defines a cluster 22 and provides capabilities to improve performance in the searching for other ACUs 18 to meet a particular bid, but also provides a convenient method for programming particular clusters 22 into the system or in dynamically modifying those clusters 22. Changing the allegiance of ACU 18a is readily done by redirecting it to a different directory facilitator 26, for example the directory facilitator 26 of supervisory agent cluster 22d, such as may allow it to take advantage of resources of ACUs 18 in supervisory agent cluster 22d. Conversely, the ACUs 18′″ of the supervisory agent cluster 22d may communicate with selected ones of the ACUs 18 in the distribution system clusters 22a-22c by connecting to their directory facilitators 26a-26c of their clusters 22a-22c.

The directory facilitators 26 may be implemented within ACUs 18 in a manner ancillary to the other logical functions of the ACUs 18 or in separate hardware attached to the network. Insofar as the directory facilitators 26 are relatively simple tables having the ability to parse requests from the ACUs 18 during bidding, multiple directory facilitators 26 may be contained in hardware for one particular ACU 18 and may be freely created as additional clusters 26 need to be defined.

Referring now to FIG. 4, a particular ACU 18 in attempting to implement a job instruction may thus start by looking at a directory facilitator 26a associated with its cluster 22 to see if it can obtain sufficient resources to create a bid chain on the particular job. Thus, for example, an ACU 18 associated with a pump may look at a small local cluster, all or a portion of the chilled water cluster 22a, to find a necessary pipe and water supply to deliver chilled water to a particular location. In the event that no successful bid is created, or the bid chains do not meet certain threshold criteria, the ACU 18 may expand its cluster by examining also an additional directory facilitator 26a to create an expanded cluster 22, for example, including adjacent distribution services 12. This is the case for an ACU 18 associated with a pump which cannot produce or find sufficient pumping capacity in its natural cluster 22, and thus examines ACUs 18 of the electrical power cluster 22b to look for solutions which may, for example, include providing additional power to a disabled pump. A nested hierarchy of directory facilitators 26 providing a dynamically changing cluster can thus be created.

The definition of clusters 22 may change arbitrarily with new clusters 22 created and old clusters 22 destroyed as determined by the progress of the bid, an operational state of the control system, or under the control of supervisory ACUs 18 of supervisory agent cluster 22d.

The organization of ACUs 18 into clusters 22 permits various levels of granularity and problem-solving, and flexible trade-offs between solution time, bandwidth and problem solving sophistication. The clusters 22 may be used not simply for control, but also for other ACU functions, such as simulation, reconfiguration, monitoring, modeling, diagnosis or prediction.

The directory facilitators 26 may provide “blackboard” communication techniques, in which communication between ACUs 18 is accomplished on demand by exchanging information entered on a blackboard without the need for broadcasting or point-to-point communication.

It will be understood by one of ordinary skill in the art that the clusters 22 can provide diagnostics, re-configuration, control, surveillance, and threat assessment/risk assessment as well as simple control of nodes and branches and that although the examples given are for a ship systems they are applicable equally to commercial, industrial, and vehicle (e.g. aircraft) systems. The ACU and clusters described above are those used in distribution services but the invention does not preclude connections with other relevant systems . and components such as propulsion components that may need to be part of the cluster but are not technically a distribution service.

It is specifically intended that the present invention not be limited to the embodiments and illustrations contained herein, but include modified forms of those embodiments including portions of the embodiments and combinations of elements of different embodiments as come within the scope of the following claims.

1. An autonomous control system for managing at least two different distribution services, each distribution service providing distribution nodes and branches, the autonomous control system comprising:
a plurality of autonomous cooperating units at least some of which are associated with nodes and branches of each distribution service, each autonomous cooperating unit operates to cooperatively implement a job command by a bidding process among autonomous control units associated with a predefined cluster related to one of the distribution services; and
wherein at least one of the autonomous cooperating units is programmed to cooperatively implement the job command by a bidding process among autonomous control units associated with a predefined cluster related to at least two of the distribution services.

2. The autonomous control system of claim 1 wherein the distribution services include the distribution of a physical material through the branches among the nodes.

3. The autonomous control system of claim 2 wherein the physical material is selected from the group consisting of: compressed air, conditioned air, chilled water, fuel, chilled air, fire water, ballast water.

4. The autonomous control system of claim 2 wherein the nodes are pumps and valves and tanks and the branches are pipes.

5. The autonomous control system of claim 1 wherein the distribution services include the distribution of electrical power.

6. The autonomous control system of claim 5 wherein the nodes are switches and power conversion and power routing devices and the branches are wires.

7. The autonomous control system of claim 1 wherein the autonomous control units are programmed to cooperatively implement the job command by a bidding process among autonomous control units associated with a predefined cluster related to at least two of the distribution services is not associated with a node or branch of a distribution service.

8. The autonomous control system of claim 1 further including a plurality of directory facilitators communicating with multiple autonomous control units, wherein the plurality of autonomous control units communicate in the bidding process among autonomous control units of a predefined cluster defined by the directory facilitator.

9. The autonomous control system of claim 1 wherein an autonomous cooperative unit may communicate with multiple directory facilitators.

10. The autonomous control system of claim 1 wherein an autonomous control unit may connect to different numbers of directory facilitators under predefined conditions of the bidding process.

11. An autonomous control system for managing a process, the autonomous cooperative system comprising:
a plurality of autonomous control units programmed to cooperatively implement a job command by a bidding process among autonomous control units associated with a predefined cluster, the predefined clusters including less than all autonomous control units;
wherein a subset of the autonomous control units are programmed to cooperatively implement a job command by a bidding process among autonomous control units associated at least two of the predefined clusters.

12. The autonomous control system of claim 11 wherein an association of autonomous control units and clusters changes dynamically as a result of the bidding process.

13. The autonomous control system of claim 12 wherein clusters are associated with different distribution services for the distribution of material or power.

14. A method of managing at least two different distribution services, each distribution service providing distribution nodes and branches, the method comprising the steps of:
(a) providing an autonomous control system having a plurality of autonomous control units at least some of which are associated with nodes and branches of each distribution service, each autonomous control unit programmed to cooperatively implement a job command by a bidding process among autonomous control units associated with a predefined cluster related to one of the distribution services; and
(b) programming at least one of the autonomous control units to cooperatively implement the job command by a bidding process among autonomous control units associated with a predefined cluster related to at least two of the distribution services.

15. The method of claim 14 wherein the distribution services include the distribution of a physical material through the branches among the nodes.

16. The method of claim 15 wherein the physical material is selected from the group consisting of: compressed air, chilled water, fuel, chilled air, ballast water.

17. The method of claim 15 wherein the nodes are pumps and valves and the branches are pipes.

18. The method of claim 14 wherein the distribution services include the distribution of electrical power.

19. The method of claim 18 wherein the nodes are switches and the branches are wires.

20. The method of claim 14 wherein the autonomous control units are programmed to cooperatively implement the job command by a bidding process among autonomous control units associated with a predefined cluster related to at least two of the distribution services is not associated with a node or branch of a distribution service.

21. The method of claim 14 further including a plurality of directory facilitators communicating with multiple autonomous control units, wherein the plurality of autonomous control units are programmed to communicate in the bidding process among autonomous control units of a predefined cluster defined by the directory facilitator.

22. The method of claim 14 wherein an autonomous control unit may communicate with multiple directory facilitators.

23. The method of claim 14 wherein an autonomous control unit may connect to different numbers of directory facilitators under predefined conditions of the bidding process.
